(19) United States
(12) Patent Application Publication
(10) Pub. No.: US 2025/0296028 A1
(43) Pub. Date: Sep. 25, 2025

(54) GAS COLLECTION APPARATUS

(71) Applicant: HONDA MOTOR CO., LTD., Tokyo (JP)

(72) Inventor: Hidetaka OZAWA, Saitama (JP)

(21) Appl. No.: 19/063,343

(22) Filed: Feb. 26, 2025

(30) Foreign Application Priority Data
Mar. 25, 2024 (JP) 2024-048337

(51) Int. Cl. B01D 53/04; F16K 1/22

(52) U.S. Cl. CPC B01D 53/0407; F16K 1/222; B01D 2253/202; B01D 2257/504; B01D 2259/40088

(57) ABSTRACT

Provided is a gas collection apparatus that can suppress power consumption at a time of normal operation, and can reliably keep a valve fully closed even in a case where supply of power is lost while performing a desorption process. A carbon dioxide collection apparatus is a gas collection apparatus that is provided with: a reactor; a fan; and a third valve and a fourth valve that are of a butterfly type and are provided at a gas inlet and a gas outlet of the reactor, plate-shaped valve bodies of the third valve and fourth valve that are configured to rotate around rotary shafts, a center of rotation of the rotary shafts being offset from a center position of the valve bodies, seen from a normal direction for a plate surface of the valve bodies.

This application is based on and claims the benefit of priority from Japanese Patent Application No. 2024-048337, filed on 25 Mar. 2024, the content of which is incorporated herein by reference.

### BACKGROUND OF THE INVENTION

### Field of the Invention

The present disclosure pertains to a gas collection apparatus.

### Related Art

Conventionally, in order to reduce the concentration of carbon dioxide (CO₂) in ambient air or the like, for example, direct air capture (DAC) for collecting CO₂ in ambient air is known to be employed in a gas collection apparatus. In a DAC system, for example, a gas such as air that includes CO₂ is sucked into a reactor that holds an adsorbent to thereby cause the CO₂ to adsorb to the adsorbent, the adsorbent is heated under reduced pressure to desorb the CO₂ that was adsorbed, and the desorbed CO₂ is collected.

In a CO₂ desorption/adsorbent regeneration process for the CO₂ adsorbent in a CO₂ adsorption and desorption reactor in the DAC system, the inside of the housing for the reactor that accommodates the adsorbent is, for example, reduced in pressure from 20 kPa at absolute pressure to a pressure such as 1 kPa, and simultaneously a heat exchanger or the like that is disposed in contact with the adsorbent is used to heat the inside of the housing, for example, from 80° C. to approximately 100° C. to thereby promote CO₂ desorption.

In these circumstances, in a case of using a butterfly valve as an air introduction/discharge/sealing valve and using a biasing means (a return spring) for biasing the valve body in a certain direction, the abutment position (biasing direction) of the return spring is set to a fully open side.

A CO₂ adsorption process, which needs a valve to be kept fully open, requires a longer amount of time than a CO₂ desorption process, which requires a valve to be kept fully closed. Accordingly, in the adsorption process, holding a valve to the fully open side using an electric motor and a gear mechanism is entrusted to the force of the return spring, whereby it is possible to prevent the electric motor from consuming electric power as much as possible for the overall adsorption and desorption process. Accordingly setting a return spring as described above, in other words setting the abutment position (biasing direction) of the return spring to the fully open side is effective.

Japanese Unexamined Patent Application, Publication No. 2009-216184 discloses a butterfly valve that enables an operation for opening or closing the valve even if the rotation axis of the valve shaft does not match that of the valve plate. As a result, a flat plate-shaped valve plate is used, whereby reducing cost is addressed.

Patent Document 1: Japanese Unexamined Patent Application, Publication No. 2009-216184

### SUMMARY OF THE INVENTION

However, when a return spring abutment position (biasing direction) is set to the fully open side, in a case where, hypothetically, the supply of power is lost due to a lightning strike or another cause, there is the possibility that the valve will become fully open due to the return spring, as soon as the maintenance of the fully closed state using motor torque is stopped, due to the abutment being on the fully open side.

In a case where an adsorbent includes a solid amine, it is known that the solid amine will oxidize and degrade upon coming into contact with oxygen in a high-temperature state, leading to a significant decrease in the ability to adsorb CO₂. Degradation of the adsorbent is a situation that is to be avoided from a perspective of operating cost and also from a perspective of maintaining the amount of CO₂ collected. Accordingly, at a time such as when the supply of power is lost, it is necessary to reliably keep the valve in the fully-closed state during the desorption process, until the temperature inside the reactor reaches a level at which oxidation damage to the solid amine adsorbent will not occur for the most part, such as 60° C. or lower, for example.

A problem to be addressed by the present disclosure is to provide a gas collection apparatus that can suppress power consumption at a time of normal operation, and can reliably keep a valve fully closed even in a case where supply of power is lost while performing a desorption process.

The present disclosure solves the abovementioned problem by means of solutions such as the following. Note that, in order to facilitate understanding, description is given by adding reference symbols corresponding to an embodiment of the present disclosure, but there is no limitation thereto.

A first disclosure is a gas collection apparatus (1) that is provided with: a reactor (11) that internally holds an adsorbent (12) and is configured to execute an adsorption process for sucking in a gas including a gas to be collected and causing the adsorbent (12) to adsorb the gas to be collected, and a desorption process for desorbing the gas to be collected from the adsorbent (12) by heating around the adsorbent (12) in a state where the around the adsorbent (12) has been reduced in pressure; a fan (61) configured to supply the gas to inside the reactor (11); and a butterfly valve (23, 24) that is provided at each of a gas inlet and a gas outlet of the reactor (11), a plate-shaped valve body (23a, 24a) of the butterfly valve (23, 24) being configured to rotate around a rotary shaft (23b, 24b), and a center of rotation of the rotary shaft (23b, 24b) being offset from a center position of the valve body (23a, 24a), seen from a normal direction for a plate surface of the valve body (23a, 24a).

A second disclosure is the gas collection apparatus (1) according to the first disclosure, in which the valve (23, 24) has a return spring (23c, 24c) that biases the valve body (23a, 24a) in an open direction.

A third disclosure is the gas collection apparatus (1) according to the second disclosure, in which, letting the amount of offset of the rotary shaft (23b, 24b) be Δd (m), torque toward an opening side for the return spring (23c, 24c) when the valve body (23a, 24a) is fully closed be T_{sc} (Nm), a seal circle radius when the valve body (23a, 24a) is fully closed be R (m), and a differential pressure between the inside and outside of the reactor (11) in the desorption process be ΔP (Pa), the following relation is satisfied

$$\begin{matrix}[ Math 1 ] & \\ Δ d > \frac{{T}_{sc}}{π {R}^{2} Δ P} . & \end{matrix}$$

A fourth disclosure is the gas collection apparatus (1) according to any one of the first disclosure to the third disclosure, in which the adsorbent (12) is a solid amine and the gas to be collected is carbon dioxide.

By virtue of the present disclosure, it is possible to provide a gas collection apparatus that can suppress power consumption at a time of normal operation, and can reliably keep a valve fully closed even in a case where supply of power is lost while performing a desorption process.

### BRIEF DESCRIPTION OF THE DRAWINGS

FIG. 1 is a schematic view that illustrates a configuration pertaining to the flow of liquids in a carbon dioxide collection apparatus 1, which is a gas collection apparatus according to one embodiment of the present invention;

FIG. 2 is a schematic view that illustrates a configuration pertaining to the flow of gases in a reactor 11 in the carbon dioxide collection apparatus 1 according to the present embodiment;

FIG. 3 is a view that illustrates an example of the form of a connection between reactors 11 and a fan 61;

FIG. 4 is a view illustrating an example of a configuration of the reactor 11;

FIG. 5-1 is a view that illustrates an example of an internal configuration of a third valve 23;

FIG. 5-2 is a view that illustrates an example of an internal configuration of a fourth valve 24;

FIG. 6 is a schematic view that illustrates a butterfly valve;

FIG. 7-1 is an enlarged view of near a rubber seal in FIG. 6;

FIG. 7-2 is an enlarged view of near the rubber seal in FIG. 6;

FIG. 8 is a schematic view that illustrates a butterfly valve in which the position of a rotary shaft is shifted in the normal direction of the plate surface of a valve body, from the central surface of a seal rubber;

FIG. 9-1 is an enlarged view of near a rubber seal in FIG. 8;

FIG. 9-2 is an enlarged view of near the rubber seal in FIG. 8;

FIG. 10 is a view that illustrates both of a view in which the valve illustrated in FIG. 6 is viewed from the front thereof (normal direction of the plate surface of the valve body), and a view in which the valve illustrated in FIG. 6 is viewed from the direction of extension by the rotary shaft thereof;

FIG. 11-1 is a view that illustrates a valve for which the center of rotation of the rotary shaft is offset from the center position of the valve body, seen from the normal direction for the plate surface of the valve body; and FIG. 11-2 is a view that illustrates a valve for which the center of rotation of the rotary shaft is offset from the center position of the valve body seen from the normal direction of the plate surface of the valve body, and furthermore the position of the rotary shaft is shifted from the seal rubber center surface in the normal direction of the plate surface of the valve body.

### DETAILED DESCRIPTION OF THE INVENTION

With reference to the drawings, description is given below regarding embodiments of the present invention.

### <Overall Configuration>

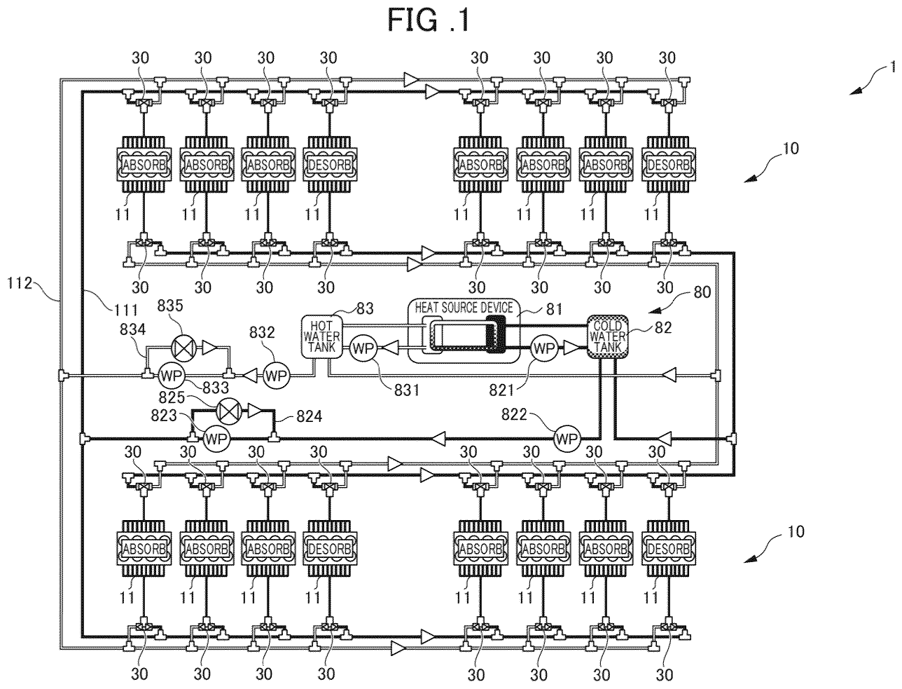

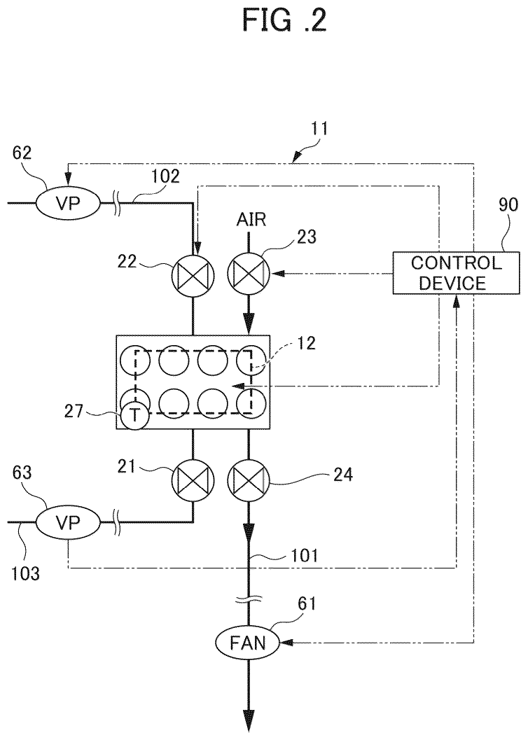

FIG. 1 is a schematic view that illustrates a configuration pertaining to the flow of liquids in a carbon dioxide collection apparatus 1, which is a gas collection apparatus according to one embodiment of the present invention. FIG. 2 is a schematic view that illustrates a configuration pertaining to the flow of gases in a reactor 11 in the carbon dioxide collection apparatus 1 according to the present embodiment. Note that illustration of a configuration pertaining to the flow of the gas in the carbon dioxide collection apparatus 1 is omitted in FIG. 1. Note that, in the following description, description is given by exemplifying the carbon dioxide collection apparatus 1 that is an example of a gas collection apparatus, but a metering/control configuration using valves in the present disclosure can also be similarly applied to a case of collecting another gas that is not carbon dioxide.

For example, the carbon dioxide collection apparatus 1 according to the present embodiment is a result of employing direct air capture (DAC), which is for collecting carbon dioxide in ambient air, in order to reduce the concentration of carbon dioxide in ambient air. Carbon dioxide collected by the carbon dioxide collection apparatus 1 is stored underground, or reused as a fuel or a material.

As illustrated in FIG. 1 and FIG. 2, the carbon dioxide collection apparatus 1 according to the present embodiment is provided with reactor units 10, fans 61, vacuum pumps 62, carbon dioxide collection pumps 63, a heat exchange apparatus 80 having a heat source device 81 formed from a heat pump, and a control apparatus 90.

Each reactor unit 10 is configured by a plurality of reactors 11 for adsorbing carbon dioxide being arranged in parallel. In the present embodiment, a total of 16 reactors 11 are arranged in accordance with a pair of left and right reactor units 10.

As illustrated in FIG. 2, each reactor 11 is a carbon dioxide collection reactor that is provided with an adsorbent 12, a first valve 21, a second valve 22, a third valve 23, a fourth valve 24, and an adsorbent temperature sensor 27.

The adsorbent 12 is disposed inside the reactor 11 in order to adsorb carbon dioxide. The adsorbent 12 is a particulate member, and has the property of adsorbing carbon dioxide in a state where the temperature is low (for example, in a range of −30° C. to 50° C.), and desorbing (discharging) carbon dioxide in a state where the temperature is high (for example, in a range from 50° C. to 110° C.) and the concentration of carbon dioxide in the vicinity is low. For example, such an adsorbent 12 may be, inter alia, a solid amine carbon dioxide adsorbent that is configured by causing a porous material such as silica to carry amine.

The first valve 21 is an on-off valve that is disposed at a connection section between the reactor 11 and a carbon dioxide line 103 for collecting carbon dioxide. A carbon dioxide collection pump 63 is disposed on the carbon dioxide line 103. The second valve 22 is an on-off valve that is disposed at a connection section between the reactor 11 and a vacuum line 102 on which a vacuum pump 62 is disposed. The third valve 23 is a butterfly valve that is disposed at an inlet for taking in ambient air or the like into the reactor 11. The fourth valve 24 is a butterfly valve that is disposed at a connection section between the reactor 11 and an adsorption line 101. A fan 61 is disposed on the adsorption line 101.

The first valve 21, the second valve 22, the third valve 23, and the fourth valve 24 are each subjected to on/off control by the control apparatus 90. The first valve 21, the second valve 22, the third valve 23, and the fourth valve 24 are each configured by a normally open butterfly valve, for example. Specific configurations of the third valve 23 and the fourth valve 24 are described below.

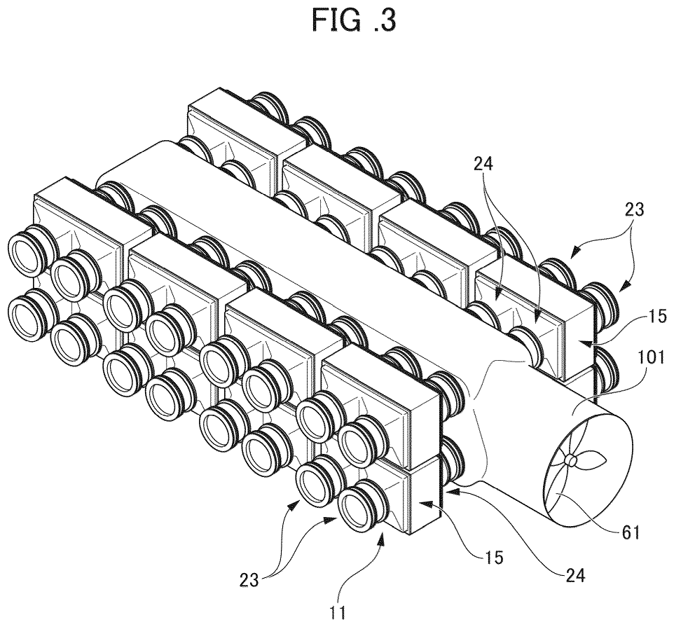

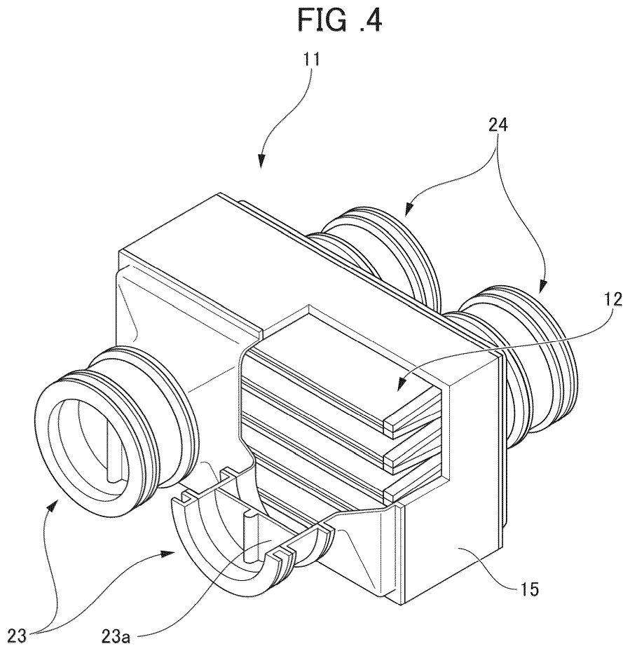

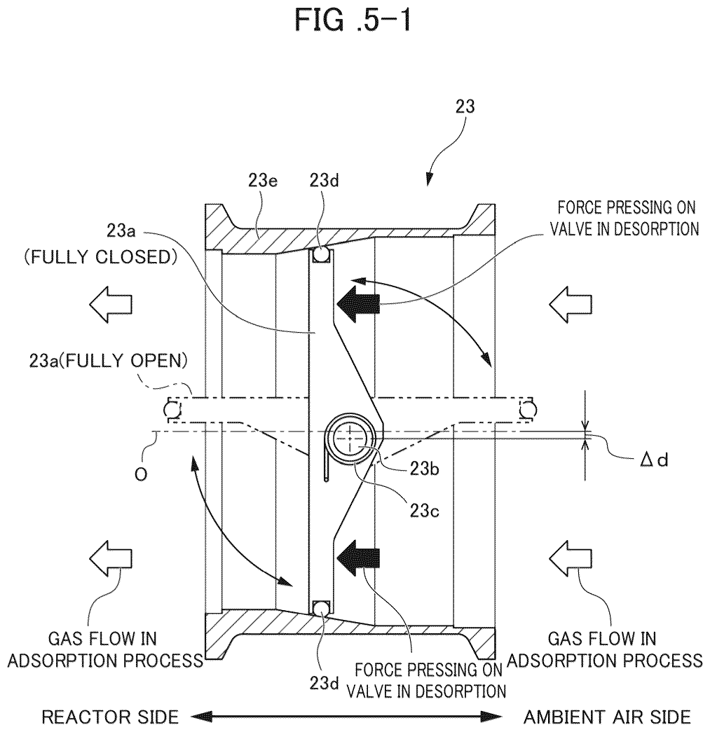

FIG. 3 is a view that illustrates an example of the form of a connection between reactors 11 and a fan 61. FIG. 4 is a view that illustrates an example of a configuration of a reactor 11, and illustrates a portion of the inside of the reactor 11. In the example illustrated in FIG. 3, eight reactors 11 are provided on each of two surfaces of a pipe that is the adsorption line 101 for a total of 16 reactors 11, the two surfaces facing each other in a direction orthogonal to the direction in which the adsorption line 101 extends (longitudinal direction). These reactors 11 are provided while being arranged in rows along the adsorption line 101, with the fourth valves 24 thereof being connected to the adsorption line 101. In other words, the adsorption line 101 has a branch connection to each of the reactors 11. Note that the arrangement illustrated in FIG. 3 of the reactors 11 with respect to the adsorption line 101 is an example, and another arrangement may be employed.

As illustrated in FIG. 4, each reactor 11 is provided with a box-shaped housing 15, as well as third valves 23 and fourth valves 24 that are provided on two surfaces that face the housing 15. The housing 15 is a box-shaped member, and is provided with the adsorbent 12 therein. For example, as illustrated in FIG. 4, the adsorbent 12 is filled between a plurality of thin plate-shaped fins of a support, the support being provided with the plurality of fins and a tube (pipe) (not illustrated), and the plurality of fins being layered in a bellows shape.

One fan 61 is provided at a portion where branched portions of the adsorption line 101 gather. The fan 61 is driven, to thereby cause the gas flow to change from “intake” to “exhaust” in each of the plurality of reactors 11 arranged upstream of the adsorption line 101. As a result, ambient air is supplied into the reactors 11.

FIG. 2 illustrates an example in which one third valve 23 and one fourth valve 24 are provided for one reactor 11 in order to facilitate understanding. However, as illustrated in FIG. 3 and FIG. 4, two of each may be provided for one reactor 11, or more than two of each may be provided for one reactor 11.

Returning to FIG. 2, the adsorbent temperature sensor 27 measures the temperature of the adsorbent 12. Measurement information from the adsorbent temperature sensor 27 is transmitted to the control apparatus 90.

The vacuum line 102 has a branch connection to each of the reactors 11. The vacuum pump 62 is disposed at a portion where branched portions for the vacuum line 102 gather. The vacuum pump 62 is driven, whereby gas inside the reactors 11 is sucked in through the vacuum line 102, and the inside of the reactors 11 enters a vacuum state or approaches the vacuum state.

The carbon dioxide line 103 has a branch connection to each of the reactors 11. The carbon dioxide collection pump 63 is disposed at a portion where the branched portions of the carbon dioxide line 103 gather. The carbon dioxide collection pump 63 causes suction force to act on carbon dioxide that flows in the carbon dioxide line 103, and stores collected carbon dioxide in a tank (not illustrated) for storing carbon dioxide.

Returning FIG. 1, description is given regarding the heat exchange apparatus 80. In circumstances where each reactor 11 in a reactor unit 10 performs a desorption process, the heat exchange apparatus 80 supplies thermal energy for heating the inside of the reactor 11 to a prescribed temperature. In addition, the heat exchange apparatus 80 collects unnecessary thermal energy in circumstances where each reactor 11 performs an adsorption process.

The heat exchange apparatus 80 according to the present embodiment is provided with the heat source device 81, a cold water tank 82, a cold water line 111, a warm water tank 83, a warm water line 112, and three-way valves 30.

The heat source device 81 exchanges heat between a heat medium flowing in the cold water line 111 and a heat medium flowing in the warm water line 112. The heat source device 81 is a heat pump, for example. The heat medium is, for example, a liquid such as water. Due to heat transfer arising at the heat source device 81, the heat medium flowing in the cold water line 111 is cooled, and the heat medium flowing in the warm water line 112 is heated.

The cold water tank 82 stores the heat medium that flows in the cold water line 111. The heat medium that flows in the cold water line 111 is stored in the cold water tank 82 and subsequently fed to the heat source device 81. In addition, the heat medium, which is cooled by the heat source device 81, is returned to the cold water tank 82 and subsequently fed to each reactor 11 through the cold water line 111. A heat source device circulation water pump 821 is disposed between the heat source device 81 and the cold water tank 82, on the cold water line 111. The heat source device circulation water pump 821 is driven, whereby the heat medium that flows in the cold water line 111 between the cold water tank 82 and the heat source device 81 circulates.

The cold water line 111 has a branch connection upstream of each reactor 11 and a branch connection downstream of each reactor 11, to thus connect the cold water tank 82 to each reactor 11. In addition, a first cold-water circulation water pump 822 and a second cold-water circulation water pump 823 are disposed between each reactor 11 and the cold water tank 82, on the cold water line 111. In addition, a circulation line 824 for returning from downstream of the second cold-water circulation water pump 823 to upstream thereof is disposed on the cold water line 111. A circulation valve 825 is disposed on this circulation line 824.

The warm water tank 83 stores the heat medium that flows in the warm water line 112. The heat medium that flows in the warm water line 112 is stored in the warm water tank 83 and subsequently fed to the heat source device 81. In addition, the heat medium, which is heated by the heat source device 81, is returned to the warm water tank 83 and subsequently fed to each reactor 11 through the warm water line 112. A heat source device circulation water pump 831 is disposed between the heat source device 81 and the warm water tank 83, on the warm water line 112. The heat source device circulation water pump 831 is driven, whereby the heat medium that flows in the warm water line 112 between the warm water tank 83 and the heat source device 81 circulates.

The warm water line 112 has a branch connection upstream of each reactor 11 and a branch connection downstream of each reactor 11, to thus connect the warm water tank 83 to each reactor 11. In addition, a first warm-water circulation water pump 832 and a second warm-water circulation water pump 833 are disposed between each reactor 11 and the warm water tank 83, on the warm water line 112. In addition, a circulation line 834 for returning from downstream of the second warm-water circulation water pump 833 to upstream thereof is disposed on the warm water line 112. A circulation valve 835 is disposed on this circulation line 834.

Each three-way valve 30 is connected to the cold water line 111, the warm water line 112, and a reactor 11. One three-way valve 30 is disposed upstream of the reactor 11, and another three-way valve 30 is disposed downstream of the reactor 11. Each three-way valve 30 is configured to enable switching between a cold-water connection state in which the cold water line 111 is connected to the reactor 11, a warm-water connection state in which the warm water line 112 is connected to the reactor 11, and a cutoff state in which connections between the reactor 11 and each of the cold water line 111 and warm water line 112 are cut off.

Flow path switching by the three-way valve 30 is controlled by the control apparatus 90. The heat medium is introduced to the reactor 11 through the three-way valve 30 disposed upstream thereof, and the heat medium is returned to the heat source device 81 side through the three-way valve 30 disposed downstream of the reactor 11.

Next, description is given regarding the control apparatus 90. The control apparatus 90 controls operation by each unit in the carbon dioxide collection apparatus 1. The control apparatus 90 controls operation, such as driving or stopping devices used to adsorb or desorb carbon dioxide. The control apparatus 90 performs, inter alia, control for opening and closing the first valve 21, second valve 22, third valves 23, and fourth valves 24 provided to each reactor 11. In addition, the control apparatus 90 performs control for driving the fans 61, the vacuum pumps 62, the carbon dioxide collection pumps 63, the heat source device circulation water pump 821, the first cold-water circulation water pump 822, the second cold-water circulation water pump 823, the heat source device circulation water pump 831, the first warm-water circulation water pump 832, the second warm-water circulation water pump 833, and the like, and performs control for opening and closing the circulation valve 825 and the circulation valve 835.

The control apparatus 90 is, for example, a computer that has a central processing unit (CPU), a read-only memory (ROM), a random-access memory (RAN), and the like. The control apparatus 90 may be configured by one device or may be configured by a plurality of devices.

### <Carbon Dioxide Collection>

Next, description is given regarding control by the control apparatus 90 for collecting carbon dioxide. The carbon dioxide collection apparatus 1 alternatingly performs an adsorption process for causing carbon dioxide in a gas such as ambient air that has been sucked in to be adsorbed by the adsorbents 12 within the reactors 11, and a desorption process for causing the carbon dioxide that was adsorbed by the adsorbent 12 to desorb, compresses the desorbed carbon dioxide and stores the compressed carbon dioxide in a tank (not illustrated) to thereby collect carbon dioxide by removing the carbon dioxide from air. In the present embodiment, the adsorption process and the desorption process are performed with amount of time for the adsorption process:amount of time for the desorption process=7:1.

The adsorption process causes carbon dioxide to be adsorbed by the adsorbent 12 inside each reactor 11. In the adsorption process, the third valves 23 and the fourth valves 24 in the reactors 11 are opened, and the first valve 21 and the second valve 22 are closed. The fan 61 is driven, whereby a flow of gas from upstream to downstream occurs, and the gas that includes carbon dioxide (for example, ambient air) is sucked in through the third valves 23. The gas that is sucked in passes by the adsorbent 12 within the reactor 11. At this point, the inside of the reactor 11 is room temperature (25° C.), and the carbon dioxide in the gas is adsorbed by the adsorbent 12. Gases other than carbon dioxide, such as nitrogen or oxygen, for example, pass through the fourth valves 24 and the adsorption line 101 and are exhausted outside of the carbon dioxide collection apparatus 1.

The desorption process causes carbon dioxide in the adsorbent 12 within the reactor 11 to desorb. In the desorption process, the first valve 21, the third valves 23, and the fourth valves 24 in the reactor 11 are closed, and the second valve 22 is opened. The vacuum pump 62 operates to suction inside of the reactor and thus reduce the pressure inside the reactor 11, whereby the reactor 11 enters a vacuum state or approaches the vacuum state. Simultaneously, using the heat exchange apparatus 80, the heat medium that is a heat source flows within the reactor 11 to supply thermal energy, raising the temperature of the adsorbent 12 in the reactor 11.

By controlling the rise in temperature by the adsorbent 12, the adsorbent 12 is also heated to a prescribed temperature (for example, 80° C.) that is sufficient for the desorption process, and the carbon dioxide that was adsorbed by the adsorbent 12 is desorbed. Next, the second valve 22, the third valves 23, and the fourth valves 24 are closed, the first valve 21 is opened, and the carbon dioxide collection pump 63 is driven, whereby the desorbed carbon dioxide collection pump 63 is stored in a tank (not illustrated) through the carbon dioxide line 103. In the present embodiment, each process is controlled such that 12 of the 16 reactors 11 execute the adsorption process and the remaining four perform the desorption process.

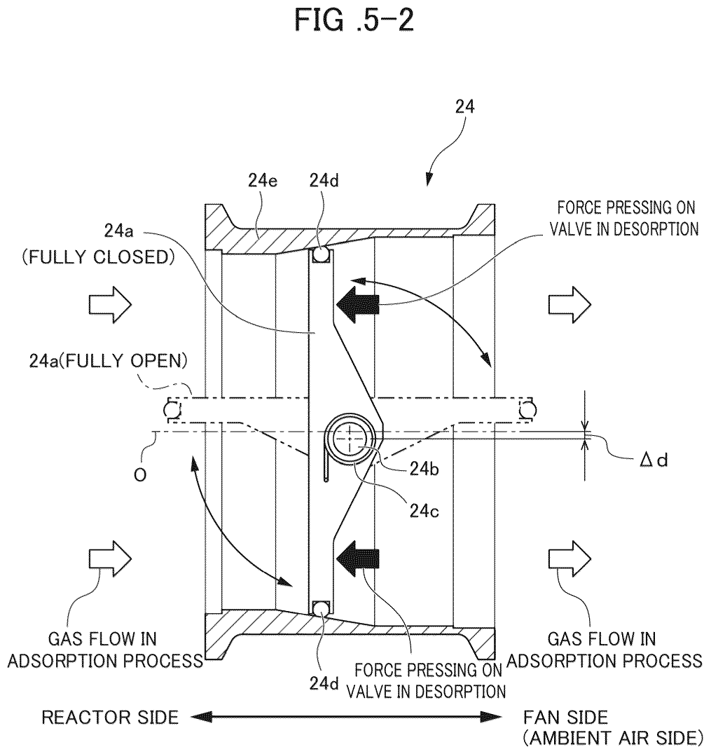

FIG. 5-1 is a view that illustrates an example of an internal configuration of a third valve 23. In FIG. 5-1, the right side of the third valve 23 is the ambient air inlet side, and the left side of the third valve 23 is connected to the reactor 11. FIG. 5-1 uses white arrows to indicate the gas flow direction in the adsorption process. In addition, FIG. 5-1 uses black arrows to indicate the direction of the force that a valve body 23a receives from ambient air due to differential pressure in a case where the reactor 11 is in the vacuum state in the desorption process. As illustrated in FIG. 5-1, the third valve 23 is provided with the valve body 23a, a rotary shaft 23b, a return spring 23c, and an actuator (not illustrated) (such as an electric motor that conveys a rotational force through a speed reduction mechanism) that is subjected to drive control by the control apparatus 90. The valve body 23a is formed to have a substantially disk shape, and seal rubber 23d is attached to the entire circumference of the outer circumferential end thereof. The rotary shaft 23b is integrally attached to the valve body 23a, and becomes the center of rotation when the valve body 23a rotates due to an opening/closing operation. The return spring 23c is a helical torsion spring. One leg of the return spring 23c is attached to a housing 23e of the third valve 23, and the other leg is attached to the rotary shaft 23b. The return spring 23c thus biases the valve body 23a and the rotary shaft 23b in the open direction. As a result, there ceases to be a need to activate the actuator in the adsorption process, and it is possible to constrain power consumption by the third valve 23 in the adsorption process. In the third valve 23 having the above-described configuration, the valve body 23a, which rotationally operates due to the actuator, rotates between a fully-closed state and a fully-open state. As a result, the third valve 23 switches between blocking ambient air flowing into the reactor 11 and letting the ambient air pass therethrough.

FIG. 5-2 is a view that illustrates an example of an internal configuration of a fourth valve 24. In FIG. 5-2, the right side of the fourth valve 24 is the fan 61 side (ambient air side), and the left side of the fourth valve 24 is connected to the reactor 11. FIG. 5-2 uses white arrows to indicate the gas flow direction in the adsorption process. In addition, FIG. 5-2 uses black arrows to indicate the direction of the force that a valve body 24a receives from ambient air due to differential pressure in a case where the reactor 11 is in the vacuum state in the desorption process. As illustrated in FIG. 5-2, the fourth valve 24 is provided with the valve body 24a, a rotary shaft 24b, a return spring 24c, and an actuator (not illustrated) (such as an electric motor that conveys a rotational force through a speed reduction mechanism) that is subjected to drive control by the control apparatus 90. The valve body 24a is formed to have a substantially disk shape, and seal rubber 24d is attached to the entire circumference of the outer circumferential end thereof. The rotary shaft 24b is integrally attached to the valve body 24a, and becomes the center of rotation when the valve body 24a rotates due to an opening/closing operation. The return spring 24c is a helical torsion spring. One leg of the return spring 24c is attached to a housing 24e of the fourth valve 24, and the other leg is attached to the rotary shaft 24b. The return spring 24c thus biases the valve body 24a and the rotary shaft 24b in the open direction. As a result, there ceases to be a need to activate the actuator in the adsorption process, and it is possible to constrain power consumption by the fourth valve 24 in the adsorption process. In the fourth valve 24 having the above-described configuration, the valve body 24a, which rotationally operates due to the actuator, rotates between a fully-closed state and a fully-open state. As a result, the fourth valve 24 switches between blocking ambient air discharged from the reactor 11 and letting the ambient air pass therethrough.

In the present embodiment, for both of the above-described third valve 23 and fourth valve 24, the centers of rotation of the rotary shafts 23b and 24b are provided at positions offset from a center position 0 of the valve bodies 23a and 24a, seen from the normal direction of the plate surface of the valve bodies 23a and 24a. In other words, in a state seen from the direction of extension by the rotary shafts 23b and 24b, the centers of rotation of the rotary shafts 23b and 24b are offset from the center position 0 of the valve bodies 23a and 24a to positions separated in a direction that follows the radial direction for the valve bodies 23a and 24a. The amount of offset, which is described above, is indicated as Δd in FIGS. 5-1 and 5-2.

Due to the offset arrangement of the rotary shafts 23b and 24b, in FIGS. 5-1 and 5-2, the distance from the center of rotation of the rotary shafts 23b and 24b to the seal rubber 23d and 24d differs between the upper side of the rotary shafts 23b and 24b and the bottom side thereof. The force that the valve bodies 23a and 24a receive from ambient air in a case where the reactor 11 is in the vacuum state in the desorption process equally acts on the plate surface of the valve bodies 23a and 24a, the force being indicated by black arrows in FIGS. 5-1 and 5-2. The force received from ambient air on the side of the rotary shafts 23b and 24b that is upward of the center of rotation in the drawings generates torque that causes the valve bodies 23a and 24a to rotate in the closed direction. In contrast, the force received from ambient air on the side of the rotary shafts 23b and 24b that is downward of the center of rotation in the drawings generates torque that causes the valve bodies 23a and 24a to rotate in the open direction.

In the upper side of the drawings, the rotary shafts 23b and 24b are disposed in an offset manner such that the distance from the center of rotation of the rotary shafts 23b and 24b to the seal rubber 23d and 24d is increased. In other words, the rotary shafts 23b and 24b are disposed in an offset manner such that rotational torque in the direction for closing the valve bodies 23a and 24a occurs in a case where uniform pressure from the ambient air side is imparted to the plate surfaces of the valve bodies 23a and 24a. Accordingly, in a case where the reactor 11 is in the vacuum state in the desorption process, the valve bodies 23a and 24a receive a force for causing rotation in the closed direction due to the force that the valve bodies 23a and 24a receive from ambient air.

If this force in the direction for the closing the valve bodies 23a and 24a received from ambient air is greater than the force in the direction for opening the valve bodies 23a and 24a received from the return springs 23c and 24c, it is possible to keep the valve bodies 23a and 24a in the closed state, even in a case where the drive force in the direction for closing the valve bodies 23a and 24a using the actuators is lost, such as at a time of a power outage. In the present embodiment, configuration is taken such that the force in the direction for closing the valve bodies 23a and 24a received from ambient air is greater than the force in the direction for opening the valve bodies 23a and 24a received from the return springs 23c and 24c. As a result, it is possible to keep the valve bodies 23a and 24a in the closed state even in a case where the drive force in the direction for closing the valve bodies 23a and 24a using the actuators is lost, such as at a time of a power outage. Accordingly, it is possible to prevent oxidation and degradation of the adsorbent in such a case.

As described above, the carbon dioxide collection apparatus 1 according to the present embodiment is provided with the return springs 23c and 24c to thereby bias the valve bodies 23a and 24a in the open direction at a time of normal operation, and it is possible to suppress power consumption at a time of normal operation. In addition, the rotary shafts 23b and 24b are disposed in an offset manner such that rotational torque in the direction for closing the valve bodies 23a and 24a occurs in a case where uniform pressure from the ambient air side is imparted to the plate surfaces of the valve bodies 23a and 24a. As a result, it is possible to keep the valve bodies 23a and 24a in the closed state even in a case where the drive force in the direction for closing the valve bodies 23a and 24a using the actuators is lost, such as at a time of a power outage. Accordingly, it is possible to prevent oxidation and degradation of the adsorbent even, inter alia, at the time of a power outage.

In this manner, the carbon dioxide collection apparatus 1 according to the present embodiment can reliably keep the valve bodies fully closed even in a case where the supply of power is lost while the desorption process is being performed, and thus it is possible to eliminate the risk of the adsorbent oxidizing and degrading. Furthermore, even if electric power inputted to a motor for driving a valve body becomes zero while holding the valve body fully closed, it is possible to keep the valve body fully closed. Accordingly, the input of electric power to the motor is limited to only times of transient operation between open and closed for the valve body, contributing to a significant reduction in power consumption. In addition, because a need to perform replacement work in conjunction with the adsorbent degrading does not arise, it becomes possible to swiftly reactivate the system in circumstances where the supply of power is restored later.

### EXAMPLES

The effectiveness of valves in the present embodiment is described by giving specific numerical examples below. Note that the numbers described below only indicate examples, and various numbers can be taken in a range where the operating principle is satisfied. In addition, the third valve 23 is not distinguished from the fourth valve 24 in the following description, and a more generalized example is described while omitting, as appropriate, reference symbols or the like for each section.

In a case where the differential pressure due to a reduction in pressure has become 90 kPa in a circular butterfly valve that is caused to function by the rotary shaft of the valve being caused to rotate by an actuator, the rotary shaft is offset by merely 2.05% from the center, whereby a 3 Nm torque acts due to the differential pressure, and the valve is reliably kept fully closed in opposition to return spring torque that is set to 2 Nm. In circumstances of transitioning to the adsorption process after the heated state in the desorption process ends and the temperature is reduced as the preliminary stage to transitioning to the adsorption process, a normal-pressure return valve is opened, whereby the reduced-pressure state is quickly released, and normal valve operation using a motor immediately becomes possible. At, for example, a time when the supply of power is lost, torque for keeping the valve fully closed acts on the valve due to the reduced-pressure environment inside the reactor during the desorption process in a high-temperature state, and it is possible to reliably suppress the occurrence of an occasion where there is oxidation and degradation due to an incursion of outside air.

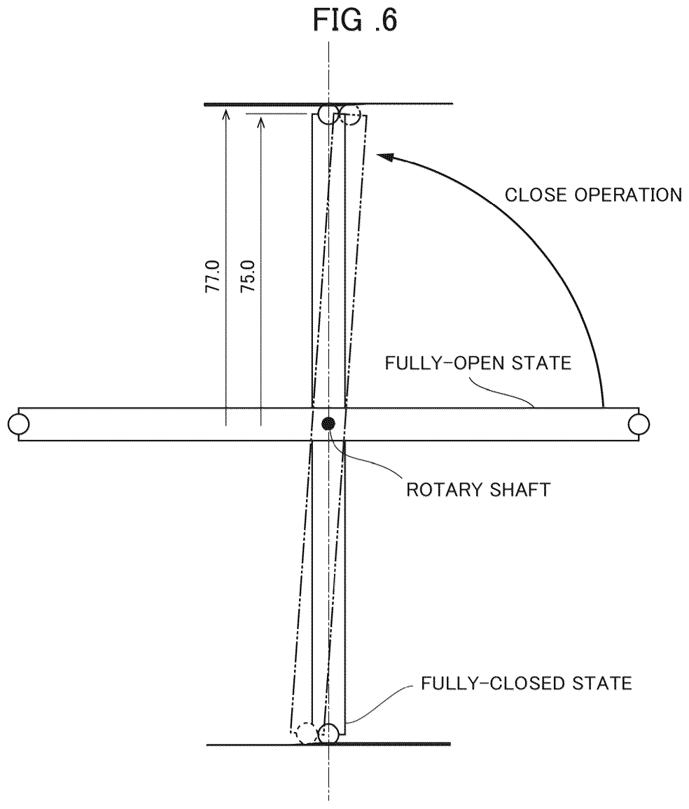

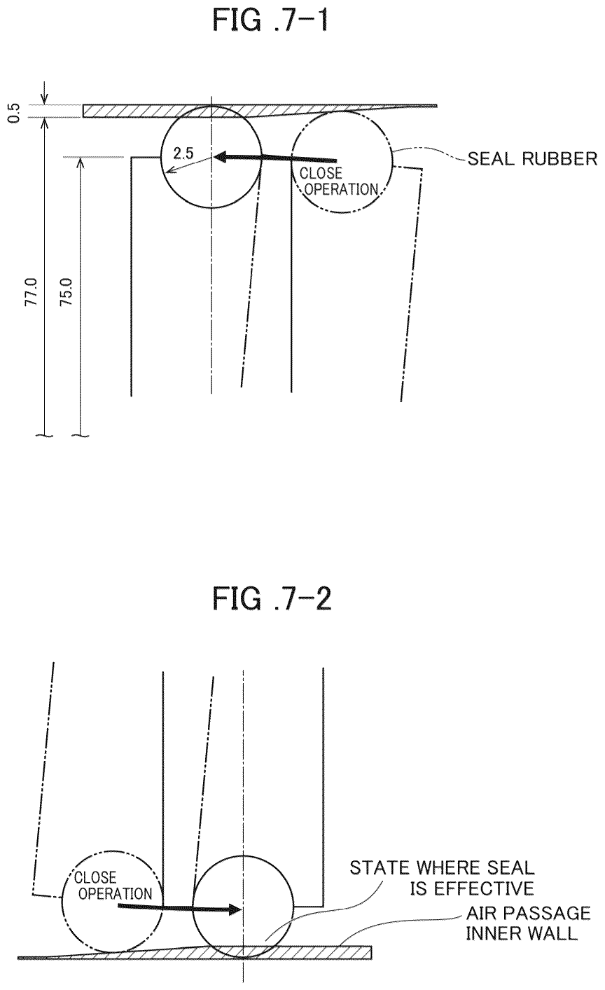

While exemplifying specific numbers in this case, the mechanism by which a valve according to the present embodiment operates is described. FIG. 6 is a schematic view that illustrates a butterfly valve. FIG. 7-1 and FIG. 7-2 are enlarged views of near a rubber seal in FIG. 6. In the example in FIG. 6, a rubber seal is laid in an outer circumferential groove of a circular butterfly valve that has a radius of 75 mm. The thickness of the rubber seal is 5 mm, the groove depth is 2.5 mm, and the outer radius of the rubber having been mounted to the groove becomes 77.5 mm. The seal rubber deforms by only 0.5 mm when the valve is fully closed, and the outer radius of the rubber at this time is 77 mm, which is equal to the inner radius of the air passage. Accordingly, the differential pressure that acts on the valve surface when the valve is fully closed is equal to the differential pressure applied to a flat disk having a radius of 77 mm. For example, in a case where differential pressure ΔP is 90 kPa, a force F (N) that acts on the flat disk having a radius of 77 mm becomes as follows.

$$F = π \times {0.077}^{2} \times 90000 = 1676.39 N$$

The rotary shaft passes through a central portion of the valve as in FIG. 6. When the valve is fully closed, contact is made with the inner wall of the air passage as in FIG. 7-1 and FIG. 7-2, and the seal rubber is crushed by only 0.5 mm, whereby seal performance is exhibited. FIG. 7-1 and FIG. 7-2 are examples of the state of a seal portion.

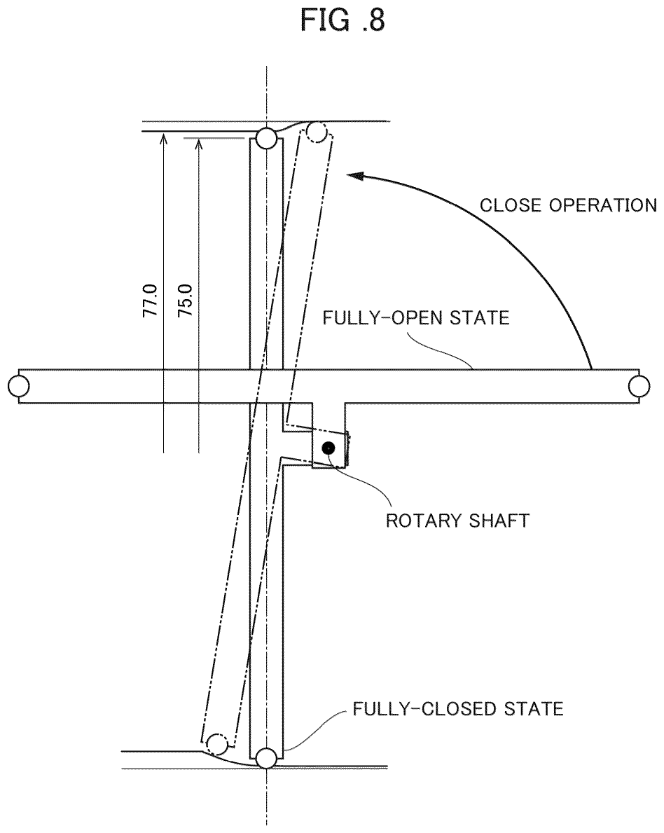

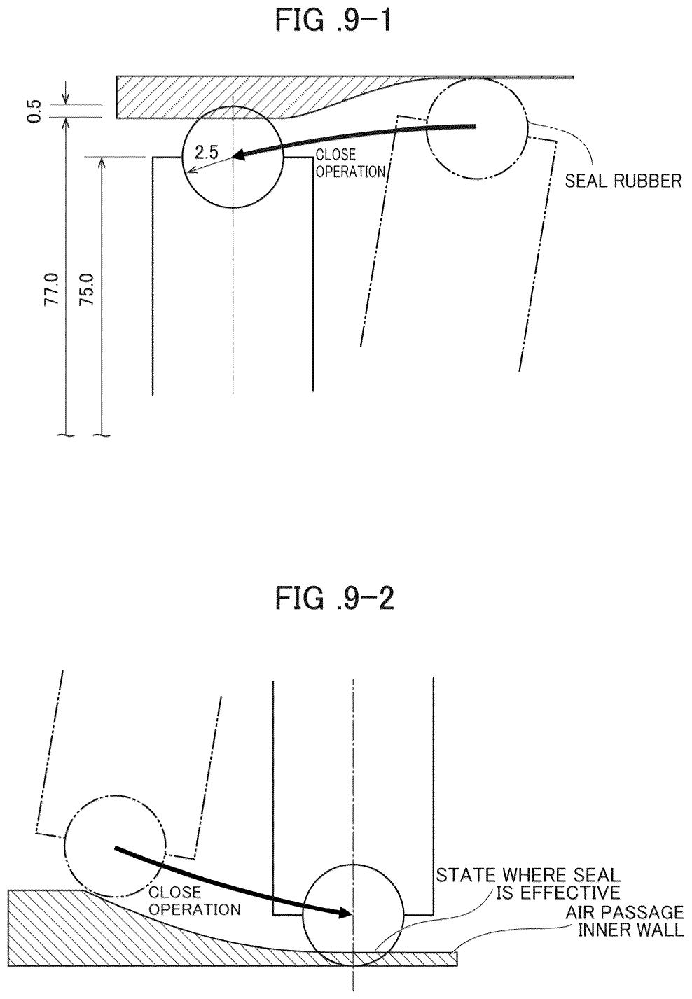

Incidentally, when the rotary shaft is present on the same plane as the central surface of the seal rubber as in FIG. 6, it is possible for the seal to be insufficient at a place where the shaft and the seal cross, and inconvenience in maintaining a degree of vacuum arises. Accordingly, in practice, it is well known that the rotary shaft is disposed by being separated by a certain level of distance in the normal direction from the plate surface of the valve body, from the central surface of the seal rubber, as in FIG. 8. FIG. 8 is a schematic view that illustrates a butterfly valve in which the position of the rotary shaft is shifted in the normal direction of the plate surface of the valve body, from the central surface of the seal rubber. FIG. 9-1 and FIG. 9-2 are enlarged views of near the rubber seal in FIG. 8. Even in the present embodiment, the rotary shafts 23b and 24b are disposed at positions that are separated in the normal direction from the plate surface of the valve bodies 23a and 24a, as illustrated in FIGS. 5-1 and 5-2.

Note that discussion regarding torque around the shaft when the valve is fully closed is that there is no impact due to the magnitude of the distance from the disk center surface for the valve body to the rotary shaft (refer to FIG. 11-1 and FIG. 11-2). Accordingly, for the purpose of simplicity, description is given here using the valve model in FIG. 6.

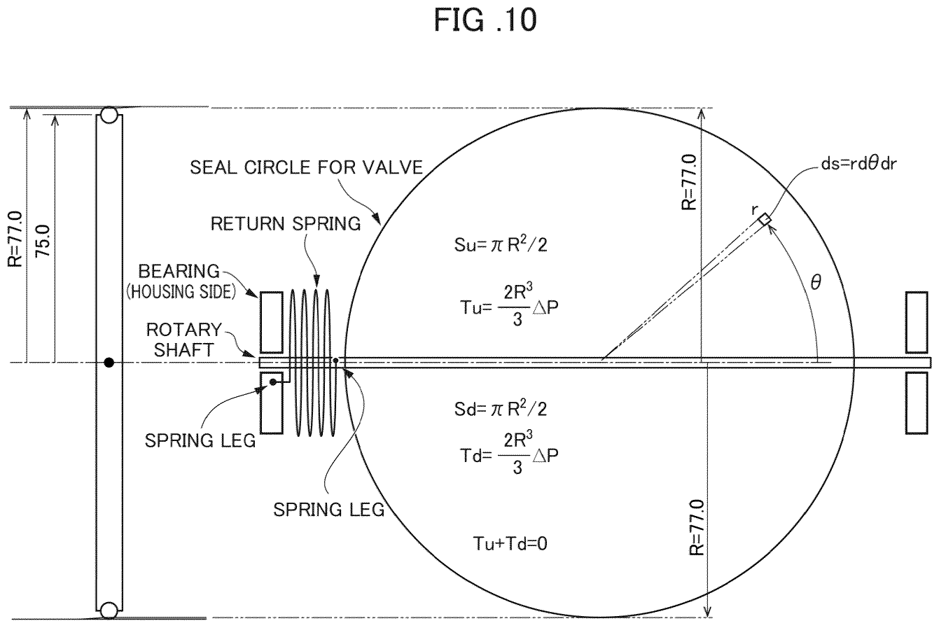

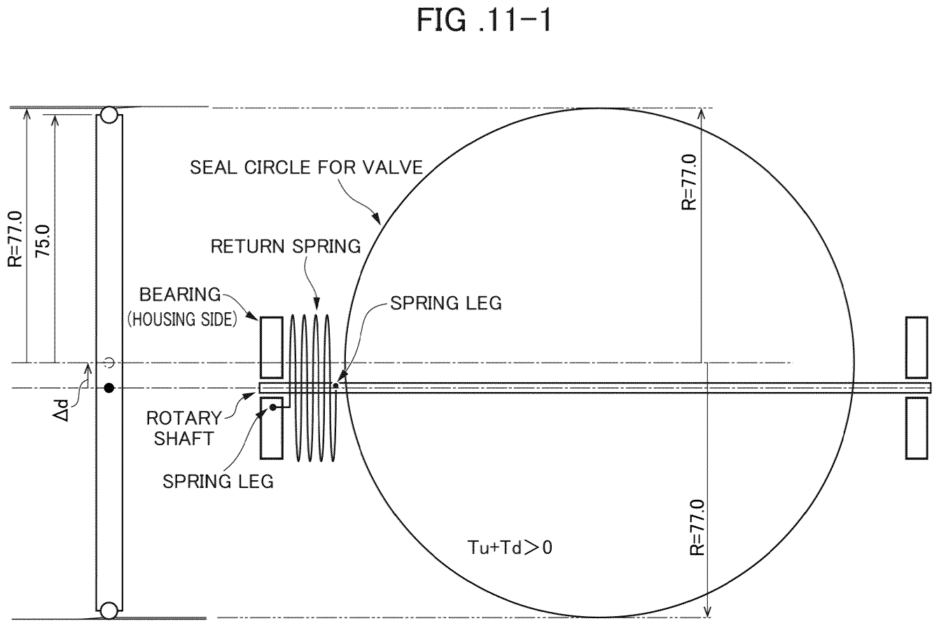

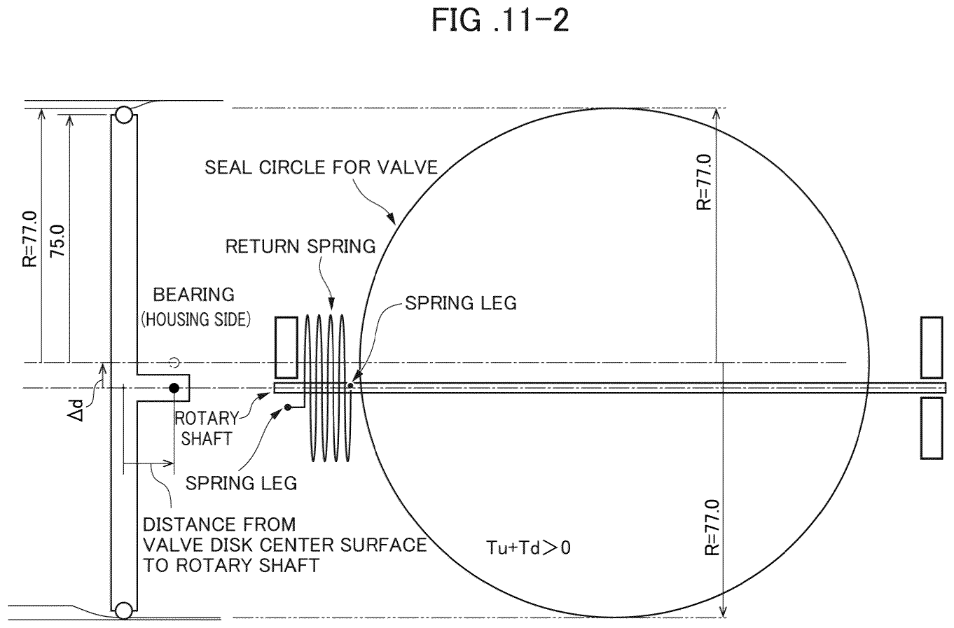

More specific description is given using numbers for the valve illustrated in FIG. 6. FIG. 10 is a view that illustrates both of a view in which the valve illustrated in FIG. 6 is viewed from the front thereof (normal direction of the plate surface of the valve body), and a view in which the valve illustrated in FIG. 6 is viewed from the direction of extension by the rotary shaft thereof. FIG. 11-1 is a view that illustrates a valve for which the center of rotation of the rotary shaft is offset from the center position of the valve body, seen from the normal direction for the plate surface of the valve body. FIG. 11-2 is a view that illustrates a valve for which the center of rotation of the rotary shaft is offset from the center position of the valve body seen from the normal direction of the plate surface of the valve body, and furthermore the position of the rotary shaft is shifted from the seal rubber center surface in the normal direction of the plate surface of the valve body. When the inside of a reactor is reduced in pressure in a state where the valve is fully closed, when the differential pressure ΔP across the valve is 90 kPa, as already mentioned, the force F (N) that acts on a flat disk having a radius of 77 mm becomes as follows.

$$F = π \times {0.077}^{2} \times 90000 = 1676.39 N$$

The seal circle radius is R=77.0 mm when the valve is fully closed, and the differential pressure across the valve orthogonally acts on the plane of a disk formed by this radius. Regarding the return spring, as illustrated in FIG. 10, for example, one end of the spring is secured to a reference securing point on a housing side and the other end is installed on the rotary shaft side, and torque from the spring acts such that the valve rotates to the fully open side. Note that the direction in which the spring torque acts is set to the fully open side because it is advisable to suppress power consumption by setting the drive force of the motor for driving the valve to zero at the fully open position, due to the length of the adsorption process that requires opening the valve being longer that the desorption process that requires the valve to be fully closed, for the carbon dioxide collection apparatus 1 according to the present embodiment.

In addition, although illustration is not given, stoppers for defining the fully-open position and the fully-closed position are realized by mechanically defining positions between the rotary shaft and the reactor housing. In a case where the rotary shaft of a valve passes through the center of the seal circle of the valve as in FIG. 6, in the fully-closed state, the differential pressure ΔP applied to an area reckoned as a circle acts on the same area: (πR²)/2 having the same shape above and below the central axis of the rotary shaft.

In addition, a torque Tᵤ due to an area Su upward from the rotary shaft in the drawing has the same magnitude as a torque T_{d} due to an area Sd downward from the rotary shaft in the drawing. Therefore, a torque T (N) around the central axis due to the differential pressure ΔP is at equilibrium around the central axis (FIG. 10). Note that the torque Tᵤ that occurs upward of the rotary shaft in the drawing due to the differential pressure ΔP is ((2R³)/3)×ΔP as indicated by formula (1).

$$\begin{matrix}[ Math 2 ] & \\ {dT}_{u} = Δ P \cdot r d θ dr \cdot r sin θ \\ {T}_{u} = 2 Δ P {{\int }_{0}}^{R} {{\int }_{0}}^{π / 2} {r}^{2} dr \cdot sin θ d θ = \frac{2 {R}^{3}}{3} Δ P & Formula ( 1 )\end{matrix}$$

$${T}_{d} = - \frac{2 {R}^{3}}{3} Δ P \\ {T}_{u} + {T}_{d} = 0 \qquad Formula ( 2 )$$

When the rotary shaft is positioned at the center of the seal circle (the circle formed when the seal rubber is annularly provided in a case of being seen from the normal direction of the plate surface of the valve body (may be referred to below as “seen from the front of the valve body” or the like)), the torque around the shaft due to the top and bottom semicircle areas being in equilibrium as in formula (2) is because, when the “center point of the circle”, which corresponds to the point of load (center of the differential pressure load) of the force F=πR²ΔP due to the differential pressure ΔP and is in accordance with the overall area of the circle, is seen from the front of the valve body (the normal direction of the plate surface of the valve body), the “center point of the circle” overlaps with the rotary shaft.

If the rotary shaft is offset by merely Δd from the center point of the disk shape of the valve body, seen from the front of the valve body, the rotary shaft will be separated by merely Δd from the point of load of the force F due to the differential pressure. Therefore, although torque around the shaft occurs, this torque is nothing but FΔd (proof omitted). Accordingly, the torque Tₚ due to differential pressure at a time of the amount of offset Δd becomes as in the following formula (3).

$${T}_{p} = F Δ d = π {R}^{2} Δ P Δ d \qquad Formula ( 3 )$$

By slightly offsetting the rotary shaft from the disk center point of the valve body, seen from the front of the valve body, it is possible to cause the torque due to differential pressure at the time of the reduction in pressure in the desorption process to occur on the valve closed side. If this generated torque has a magnitude that overcomes the torque of the return spring, it is possible to reliably keep the valve fully closed even in a case where the supply of power is lost.

In a carbon dioxide collection apparatus according to the present embodiment, the rotary shaft of a valve body is offset from the disk center of the valve body, whereby it is possible to use the differential pressure at a time of reduced pressure inside a reactor to maintain a valve-closed state. Description is given below for relationships between parameters that will be necessary in order to enable the valve-closed state to be maintained using this differential pressure. Parameters of a butterfly valve are defined as follows.

The radius of the valve body for which the shape seen from the front is circular is set to R (m). This radius R is the effective radius after also considering a portion where the rubber seal laid in the circumferential edge groove of the disk-type valve body uniformly deforms in the circumferential direction when the valve is fully closed.

The differential pressure between the inside and outside of the reactor in the desorption process is set to ΔP (Pa). The pressure outside of the reactor is normally atmospheric pressure. Assuming that the internal pressure is approximately 1 to 20 kPa, the differential pressure ΔP near 0 m from sea level will be approximately 80 to 100 kPa.

The amount of offset for the rotary shaft of the valve body is set to Δd (m). The distance (amount of offset) from the disk center point to the core of the rotary shaft, observed when the valve body is viewed from the front of the disk, is set to Δd.

The torque of the return spring toward an opening side for the return spring when the valve body is fully closed be T_{sc} (Nm)

The fully open position for the valve body is the abutment default position.

The spring constant of the return spring is set to k (Nm/rad). The axial friction of the rotary shaft of the valve body is set to T_{f} (Nm). An aging coefficient for axial friction is set to η (>1).

The angle of the valve when the valve body is fully closed is set to θ_{c} (rad). The angle θ_{c} when fully closed is set to 0 (rad).

The angle of the valve when the valve body is fully opened is set to θₒ (rad). The fully open angle θₒ with respect to the fully closed angle θ_{c} is generally +π/2 (rad).

When the valve body is fully closed, the torque for turning the valve body to the open side is merely the spring torque T_{sc} defined above.

$${T}_{s c} \qquad Formula ( 4 )$$

In addition, when the valve body is fully closed, the torque for turning the valve body to the closed side is the torque Tₚ due to the differential pressure. When the rotary shaft is offset by merely +Δd from the point of load of the force F due to the differential pressure—in other words, the center point of the valve body disk—the torque Tₚ due to the differential pressure in the case of the amount of offset Δd occurs around the shaft.

$${T}_{p} = F Δ d = π {R}^{2} Δ P Δ d \qquad Restating Formula ( 3 )$$

Furthermore, operation of the valve body that is trying to open is obstructed by the axial friction ηT_{f} for which change over time is expected. Therefore, the total torque for “preventing opening” that acts around the rotary shaft when the valve is fully closed becomes as in the following formula (5).

$${T}_{p} + η {T}_{f} \qquad Formula ( 5 )$$

In the case where the torque expressed by formula (5) overcomes the torque of the return spring (formula (4)), the valve body being fully closed at the fully closed position is maintained without using torque from the motor. In other words, if the following formula (6) is satisfied, the valve body being fully closed is maintained (held at the fully closed position).

$${T}_{p} + η {T}_{f} > {T}_{s c} \qquad Formula ( 6 )$$

Employing formula (3) and formula (4) in formula (6), the following formula (6′) is obtained.

$$π {R}^{2} Δ P Δ d + η {T}_{f} > {T}_{s c} \qquad Formula ( {6}^{′} )$$

The following formula (6″) is obtained from formula (6′).

$$\begin{matrix}[ Math 3 ] & \\ Δ d > \frac{{T}_{sc} - η {T}_{f}}{π {R}^{2} Δ P} & Formula ( {6}^{″} )\end{matrix}$$

If an amount of offset Δd of the rotary shaft is imparted such that formula (6″) is satisfied, it is possible to maintain the fully-closed state when the valve is fully closed. However, in practice, in an environment in which torque in one direction (a direct flow) referred to as the spring torque is constantly being applied, there is an alternating vibration environment due to, inter alia, an annular excitation mode for a stator that is excited by an air intake fan. Therefore, there is the possibility for an effect of securing a shaft using friction will be indeterminate in a region of time such as in excess of a several tens of seconds or several minutes. Accordingly, the possibility of drifting to the open side little by little in accordance with the spring torque cannot be denied. Accordingly, in circumstances of performing the desorption process over a long amount of time, ηT_{f} should be set to zero in formula (6″). Accordingly, it is necessary to note that the following formula (6″′) should be employed as a requirement formula for Δd.

$$\begin{matrix}[ Math 4 ] & \\ Δ d > \frac{{T}_{sc}}{π {R}^{2} Δ P} & Formula ( {6}^{″} )\end{matrix}$$

Note that T_{f}, in addition to the friction of the rotary shaft, formula (6″) also includes friction for the speed reduction mechanism, and friction of the electric motor connected via the speed reduction mechanism.

Next, description is given for an operation at the fully open position for the valve body. When the valve body is fully open, spring torque Tₛₒ is indicated by the following formula (7) from the spring torque T_{sc} for when the valve body is fully closed, the spring constant k, the valve angle θ_{c} when the valve body is fully closed that is =0 (rad), and the fully open angle θₒ (is π/2 normally).

$${T}_{so} = {T}_{s c} - k ( {θ}_{o} - {θ}_{c} ) = {T}_{s c} - k {θ}_{o} \qquad Formula ( 7 )$$

The valve body normally abuts the fully open position in the adsorption process, but this Tₛₒ is set as fully open abutment torque for merely displaying sufficient toughness with respect to an outside disturbance in the air flow due to the air fan, without using motor torque. However, when the spring constant of the return spring is set high in these circumstances, the torque T_{sc} that acts on the open side when the valve is fully closed becomes excessive, and the work performed by the motor in an operation for closing the valve when transitioning from the adsorption process to the desorption process becomes excessive, thus leading to an increase in motor specifications. In contrast, when the spring constant for the return spring is set small, the spring torque T_{sc} that acts to open the valve when the valve is fully closed can be set to a value close to Tₛₒ, but the same set load Tₛₒ must be provided at a small spring constant, and thus the spring structure of the return spring gets larger, leading to a larger overall structure. It is necessary to set an appropriate spring constant in consideration of this relationship, for the return spring.

Description is given for the following numbers as a more specific numerical example.
The circular valve body radius is set to R=0.077 (m).
The differential pressure between the inside and outside of the reactor in the desorption process is set to ΔP=90 (kPa).
The torque for the return spring when the valve is fully closed is set to T_{sc}=2 (Nm).
The spring constant of the return spring is set to k=2/π (Nm/rad).
The friction around the shaft is set to T_{f}=0.2 (Nm), but is unnecessary in formula (6′″).
The aging coefficient for axial friction is set to η=2.5, but is unnecessary in formula (6″′).
The angle of the valve when the valve body is fully closed is set to θ_{c}=0 (rad).
The angle of the valve when the valve body is fully opened is set to θₒ=π/2 (rad).

The above are applied to formula (6″′) to obtain the following formula.

$$\begin{matrix}[ Math 5 ] & \\ Δ d > \frac{{T}_{sc}}{π {R}^{2} Δ P} = 1.19 ( mm ) & \end{matrix}$$

The minimum value of Δd is given as 1.19 mm, but this value is 1.55% of the effective radius R of the valve body, and this fact can be referred to as “the offset Δd is 1.55%”. In the case of the numerical examples described above, the amount of offset Δd is set to a value greater than 1.55% (1.19 mm), whereby it becomes possible to reliably maintain the fully-closed state at a time of the desorption process. However, in practice, it is necessary to consider, inter alia, manufacturing variation for the spring load, for example. Accordingly, it becomes necessary to, for example, set an appropriate value as a margin with respect to 1.19 mm, 20% for example, and set the amount of offset Δd to 1.86% (1.19×1.2=1.43 mm).

As an extreme numerical setting, in a case of a setting such as where a very strong torque is caused to act on the fully open side with the spring load for the return spring when the valve is fully closed being multiplied by 10 and the spring constant for the return spring being multiplied by 10, in other words, with respect to the numerical example described above, a case where the torque of the return spring when the valve is fully closed is set to T_{sc}=20 (Nm) and the return spring spring constant is set to k=20/π (Nm/rad), the following relationship is obtained from formula (6″′).

Δd>11.93(mm)

In this case, from formula (6′″), the amount of offset Δd is greater than 15.49% (1.93 mm). Therefore, it becomes necessary to, for example, set a margin of 20% with respect to 11.93 mm, and set the amount of offset Δd to 18.59% (11.93×1.2=14.32 mm).

In both of the two numerical examples described above, the amount of offset Δd fits within a range that sufficiently enables smooth valve operation spatially, and is easily realized. Accordingly, by imparting the offset Δd, it is possible to reliably maintain the fully-closed state for the valve body in the desorption process.

### EXPLANATION OF REFERENCE NUMERALS

1 Carbon dioxide collection apparatus
10 Reactor unit
11 Reactor
12 Adsorbent
15 Housing
21 First valve
22 Second valve
23 Third valve
23a Valve body
23b Rotary shaft
23c Return spring
23d Seal rubber
23e Housing
24 Fourth valve
24a Valve body
24b Rotary shaft
24c Return spring
24d Seal rubber
24e Housing
27 Adsorbent temperature sensor
61 Fan
62 Vacuum pump
63 Carbon dioxide collection pump
80 Heat exchange apparatus
81 Heat source device
90 Control apparatus
101 Adsorption line
102 Vacuum line
103 Carbon dioxide line

What is claimed is:

1. A gas collection apparatus, comprising:
a reactor that internally holds an adsorbent and is configured to execute an adsorption process for sucking in a gas including a gas to be collected and causing the adsorbent to adsorb the gas to be collected, and a desorption process for desorbing the gas to be collected from the adsorbent by heating around the adsorbent in a state where the around the adsorbent has been reduced in pressure;
a fan configured to supply the gas to inside the reactor; and
a butterfly valve provided at each of a gas inlet and a gas outlet of the reactor, a valve body of the butterfly valve having a plate shape and being configured to rotate around a rotary shaft,
wherein a center of rotation of the rotary shaft is offset from a center position of the valve body, seen from a normal direction for a plate surface of the valve body.

2. The gas collection apparatus according to claim 1, wherein the butterfly valve has a return spring that biases the valve body in an open direction.

3. The gas collection apparatus according to claim 2, wherein
letting the amount of offset of the rotary shaft be Δd (m),
torque of the return spring toward an opening side for the return spring when the valve body is fully closed be T_{sc} (Nm), a seal circle radius when the valve body is fully closed be R (m), and
a differential pressure between the inside and outside of the reactor in the desorption process be ΔP (Pa),
the following relation is satisfied
$$\begin{matrix}[ Math 1 ] & \\ Δ d > \frac{{T}_{s c}}{π {R}^{2} - Δ P} . & \end{matrix}$$

4. The gas collection apparatus according to claim 1, wherein
the adsorbent is a solid amine, and
the gas to be collected is carbon dioxide.
